(19) United States
(12) Patent Application Publication
(10) Pub. No.: US 2009/0259931 A1
(43) Pub. Date: Oct. 15, 2009

(54) TABLE GENERATING METHOD AND TABLE GENERATING APPARATUS

(75) Inventor: Kunimasa Fujisawa, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/421,526

(22) Filed: Apr. 9, 2009

(30) Foreign Application Priority Data
Apr. 11, 2008 (JP) 2008-103836

(51) Int. Cl. G06F 17/00

(52) U.S. Cl. 715/227

(57) ABSTRACT

A table generating apparatus calculates the total of the values of weights set for the widths of a plurality of columns included in a table, and determines the width of each of the columns based on the table width, the total, and the weight set for the width of each of the columns.

### BACKGROUND OF THE INVENTION

1. Field of the Invention

The present invention relates to a table generating method and a table generating apparatus.

2. Description of the Related Art

The technology for determining the width of each of columns of a table based on the length of data included in the table has been available (refer to Japanese Patent Laid-Open No. 4-165570 and Japanese Patent Laid-Open No. 4-165560, for example).

Further, existing word processors and/or table-calculation software programs allow for deleting and/or inserting a column from and/or into a table, making settings so that the column is displayed and/or hidden, and so forth.

However, if data of a table showing nothing but columns with predetermined small widths is output, the width of the table becomes significantly smaller than the sheet size, or the table width becomes larger than the sheet size, which impairs the layout of a document.

It has been possible to determine the column width based on the length of data for inputting. However, since the column width was determined based on the data for inputting in the above-described case, it has been difficult to keep the table width constant.

Further, it becomes possible to declare the column width in the Hyper Text Markup Language (HTML), as the proportion of the column width to the table width. When describing a table in the HTML, the table width and the proportion of the column width can be described.

However, when the total of the values of the proportions of the column widths to the table width does not reach 100%, for example, when the table has a width of 150 mm and shows a column attaining a proportion of 30%, a column attaining a proportion of 20%, and another column attaining another proportion of 20%, the widths of the above-described columns become 45 mm, 30 mm, and 30 mm so that a table having a width of 105 mm is output. Since the actually generated table has the width of 105 mm even though data of a document is laid out so that a table shown in the document has the width of 150 mm, the layout of the document is impaired.

### SUMMARY OF THE INVENTION

The present invention allows for generating a column having an appropriate width, the width corresponding to the width of a table.

The present invention also allows for generating a table without impairing the layout of a document.

Moreover, the present invention also allows for providing a table generating method used to calculate the total of the values of weights set for the widths of a plurality of columns included in a table, and determine the width of each of the columns based on the width of the table, the total, and the weight set for the width of each of the columns.

Additionally, the present invention also allows for providing a generating apparatus including a calculating unit configured to calculate the total of values of weights set for the widths of a plurality of columns included in a table, and a determining unit configured to determine the width of each of the columns based on the width of the table, the total, and the weight set for the width of each of the columns.

Further aspects and features of the present invention will become apparent from the following description of exemplary embodiments with reference to the attached drawings.

### BRIEF DESCRIPTION OF THE DRAWINGS

FIG. 1 is a block diagram showing the configuration of a document generating system having a table-generating function according to an embodiment of the present invention.

FIG. 2 is a diagram showing format information used by the document generating system according to the above-described embodiment.

FIG. 3 is a flowchart showing processing procedures performed by the document generating system according to the above-described embodiment.

FIG. 4 is a flowchart showing processing procedures performed by a document generating system according to another embodiment of the present invention.

FIG. 5 shows a table displayed on a display monitor.

FIG. 6 is a diagram showing the state of the table displayed on the display monitor when a user selects a column for hiding.

FIG. 7 is a diagram showing the state of the table displayed on the display monitor after the column for hiding is selected.

FIG. 8 is a diagram showing format information used by a document generating system according to another embodiment of the present invention.

FIG. 9 is a diagram showing data records merged into the format information.

FIG. 10 is a flowchart showing processing procedures performed by the document generating system according to the above-described embodiment.

FIG. 11 is a diagram showing exemplary business-form template data generated in the above-described embodiment.

FIG. 12 is a diagram showing an exemplary business form generated in the above-described embodiment.

### DESCRIPTION OF THE EMBODIMENTS

Hereinafter, embodiments of the present invention will be described in detail with reference to the attached drawings.

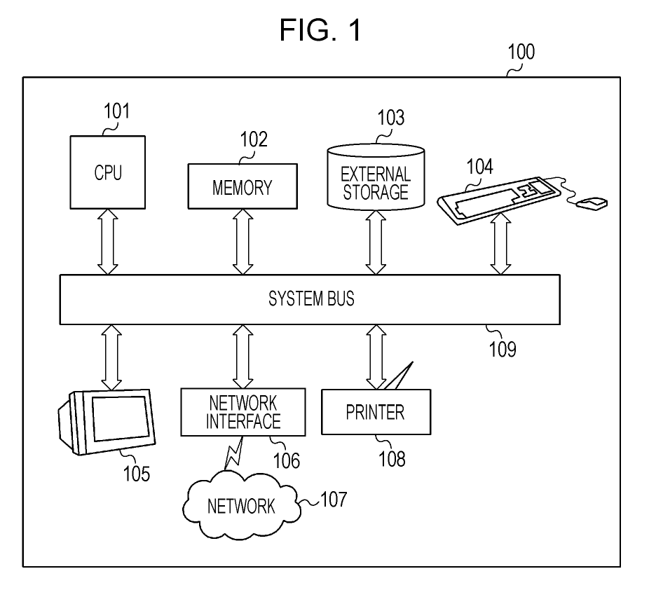

FIG. 1 is a block diagram showing the configuration of a document generating system which is a table generating system having a table generating function according to an embodiment of the present invention.

A document generating system 100 is the table generating system according to the above-described embodiment. A central processing unit (CPU) 101 controls the entire document generating system 100. A memory 102 temporarily stores programs and/or data transmitted from an external storage device 103, for example. The external storage device 103 includes a hard disk, a memory card, and so forth.

An input device 104 includes a pointing device, a keyboard, etc. through which a user performs operations including inputting and/or editing text data, generating and/or changing table data, etc. A display monitor 105 is provided to display the text data edited by the user and/or the table data generated through the document generating system 100. A network interface 106 is provided to access a network 107. A printer 108 is provided. Each of the above-described units 101 to 108 is connected to a system bus 109.

Hereinafter, first, second, and third embodiments of the present invention will be described. The document generating systems 100 according to the first to third embodiments described below share a configuration shown in FIG. 1.

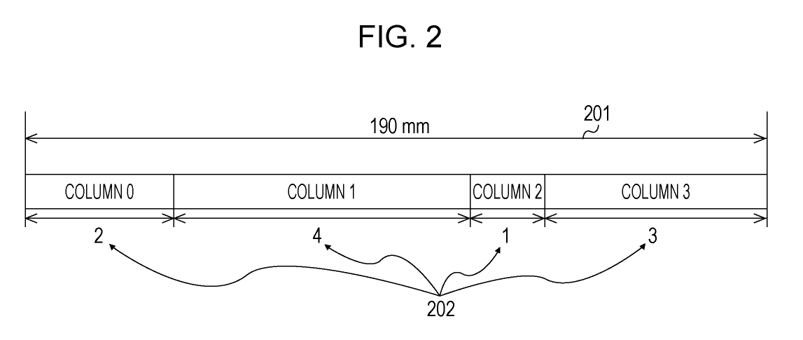

First, the first embodiment of the present invention will be described. A table generated through the document generating system 100 of the first embodiment shows width information 201 indicating the width of the table and weight information items 202 indicating the weights of the widths of columns, as format information shown in FIG. 2. The table width information 201 and the column-width weight information items 202 are stored in the external storage device 103 including a hard disk, a memory card, and so forth. The table width information 201 and the column-width weight information items 202 may be stored in a server provided on the network 107 and accessed through the network interface 106.

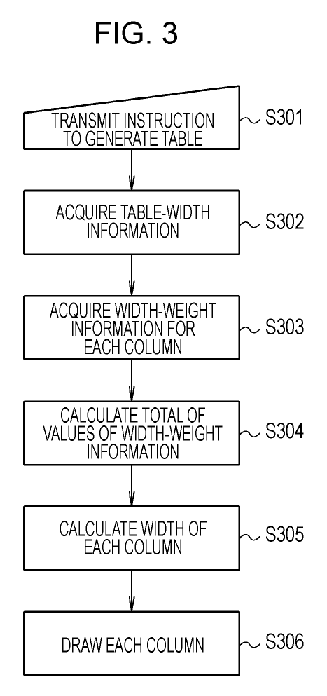

FIG. 3 is a flowchart showing processing procedures performed by the document generating system 100 of the first embodiment.

First, upon receiving an instruction to generate the table, the instruction being transmitted from the user, at step S301, the CPU 101 performs column-width calculating processing, so as to determine the widths of the columns of the table, and performs drawing processing, so as to actually draw the table.

During the column-width calculating processing, the CPU 101 acquires the width information 201 from the format information shown in FIG. 2 at step S302.

Then, the CPU 101 acquires the width-weight information item 202 of each column at step S303.

Next, at step S304, the CPU 101 calculates the total of the values of the width-weight information items 202 acquired for the columns at step S303.

Next, the CPU 101 calculates the width of each column at step S305 based on Equation (1) shown below. That is to say, the CPU 101 multiplies the value of the ratio between each of the weight information items 202 and the total of the values of the weight information items 202 of the columns by the value of the width information 201 based on Equation (1), so as to calculate the width of each column. Here, the sign Wi shown in Equation (1) is the weight information item 202 acquired at step S303, where the weight information item 202 indicates the weight of the width of each column. The sign Tw shown in Equation (1) indicates the width information 201 acquired at step S302. Further, the sign ΣWi shown in Equation (1) indicates the total of the values of the weight information items 202 of the widths of the columns, the total being calculated at step S304.

$$\begin{matrix}[ Numerical Expression 1 ] & \\ Column width = \frac{Wi}{{\sum }_{i = 1}^{n} Wi} Tw & Equation ( 1 )\end{matrix}$$

Wi=the weight of column width

Tw=the table width

n=the number of columns for outputting

Next, at step S306, the CPU 101 draws or generates each column so that the column has the width calculated at step S304.

When the table is drawn through the above-described processing procedures, “column 0” has a width of 38 mm, “column 1” has a width of 76 mm, “column 2” has a width of 19 mm, and “column 3” has a width of 57 mm, for example. The total of the above-described widths becomes 190 mm, which is equivalent to the value of the width information 201 of the format information shown in FIG. 2.

Thus, the above-described embodiment allows for generating a table showing columns, where each of the columns has a width determined based on the weight information item 202. Therefore, for increasing the width of a certain column without changing the width of the entire table, the weight information item 202 corresponding to the column width is increased so that a table is generated, the table showing the column having an increased width. Further, for decreasing the width of a certain column, a table showing the column having a decreased width can be generated. Namely, the above-described embodiment allows for generating a column having an appropriate width corresponding to the table width so that the table can be generated without impairing the layout (without changing the length of the table width).

Next, the second embodiment of the present invention will be described. In the second embodiment, a table generated through the document generating system 100 is also provided with the table-width information 201 and the column-width weight information items 202 that are shown in FIG. 2, as the format information. Since the configuration of the above-described document generating system 100 is equivalent to that shown in FIG. 1, the description of the configuration is omitted.

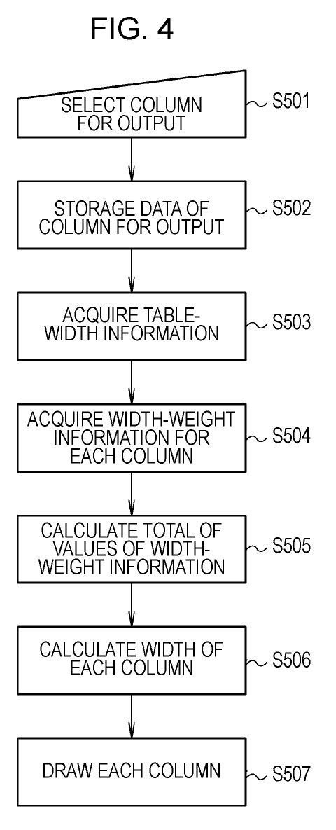

FIG. 4 is a flowchart showing processing procedures performed by the document generating system 100 according to the second embodiment.

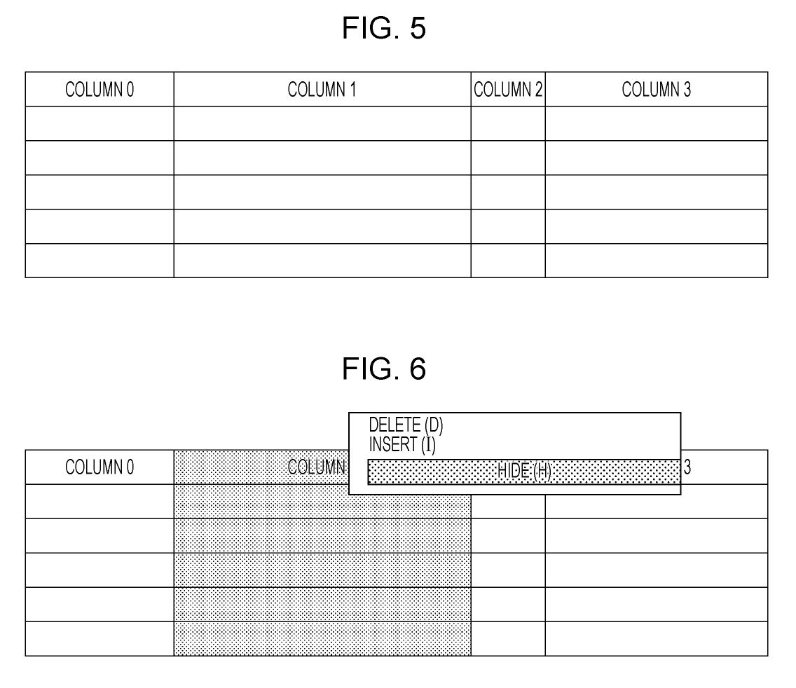

Suppose a table shown in FIG. 5 is displayed on the display monitor 105, the user selects a column for hiding and selects “hide” from a menu so that the column is hidden by using the input device 104 including a pointing device, a keyboard, and so forth, as shown in FIG. 6, the CPU 101 selects columns for outputting at step S501. In the above-described embodiment, the columns 0, 2, and 3 are selected.

Next, the CPU 101 stores data of an arrangement of the identifiers of the columns determined at step S501 in an output-column storage area of the memory 102 at step S502.

For example, when the user determines to hide “column 1” of the table, data of an arrangement of the identifiers of “column 0”, “column 2”, and “column 3” is stored.

When the user selects the column for hiding, table redraw processing is started. The table redraw processing is divided into column-width calculating processing performed to determine the column width and drawing processing performed to actually draw the table.

During the column-width calculating processing, the CPU 101 acquires the width information 201 from the format information shown in FIG. 2, for example, at step S503.

Next, the CPU 101 acquires the column-width weight information item 202 corresponding to the identifier of the column of which data is stored in the output-column storage area of the memory 102 at step S504.

Then, at step S505, the CPU 101 calculates the total of the values of the width weight information items 202 of the columns for outputting, the column-width weight information items 202 being acquired at step S504. In the above-described embodiment, the total of the values of the weight information items of “column 0”, “column 2”, and “column 3” (2, 1, and 3) is calculated.

Next, the CPU 101 calculates the width of the column corresponding to the identifier of the column of which data is stored in the output-column storage area of the memory 102 based on Equation (1), at step S506.

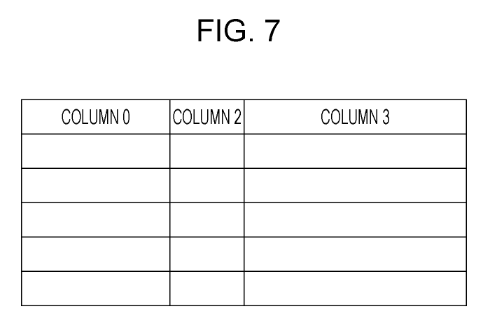

Then, at step S507, the CPU 101 draws the column corresponding to the identifier of the column of which data is stored in the output-column storage area so that the column has the width calculated at step S505, as shown in FIG. 7.

When the table is drawn through the above-described processing procedures, “column 0” has a width of 63.3 mm, “column 2” has a width of 31.7 mm, and “column 3” has a width of 95 mm, for example. The total of the above-described widths becomes 190 mm, which is equivalent to the value of the table width obtained before the operation for selecting the column for display is performed.

Thus, in the above-described embodiment, the width of a column selected as a target of outputting and showing on the table is calculated based on the weight information of the selected column. Therefore, even though the column which is output and shown on the table is changed and the number of the columns shown on the table is increased and/or decreased, the above-described embodiment allows for generating each of the columns having appropriate widths without changing the width of the entire table, which prevents the table layout from being impaired.

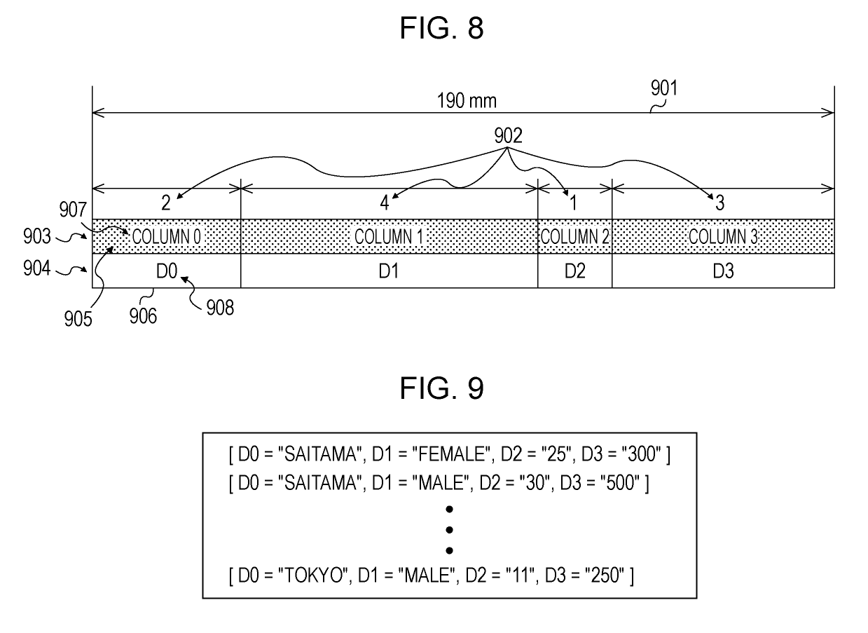

Next, the third embodiment of the present invention will be described. A table generated through the document generating system 100 according to the above-described embodiment is provided with data of a business-form template shown in FIG. 8, as the format information. Here, since the configuration of the document generating system 100 according to the above-described embodiment is equivalent to that shown in FIG. 1, the description of the configuration is omitted.

The business-form template shown in FIG. 8 includes table width information 901 which is the table format information, column-width weight information items 902, a table label line 903, and a data-description line 904 on which the data-insertion destination is described. The business-form template data is stored in the external storage device 103 including a hard disk, a memory card, and so forth. Of course, the business-form template data may be stored in a server provided on the network 107 and accessed through the network interface 106.

The table label line 903 includes label cells 905 corresponding to the columns of the table, and each of the label cells 905 retains data of a table-label character string 907.

The data description line 904 on which the data-insertion destination is described includes data description cells 906. Each of the data description cells 906 retains data of a name-of-data-for-insertion 908.

Data which should be merged into the business-form template data is data of an arrangement of records including groups of at least two data names (such as DO) and values (such as Saitama) that are shown in FIG. 9. The above-described data is stored in the external storage device 103 including a hard disk, a memory card, and so forth. The above-described data may be acquired from a server provided on the network 107 through a removable medium and/or the network interface 106.

When generating a business form by merging the data into the business-form template data, the name of data which should be inserted and the value of the data bearing the same name, which are included in each record, are inserted in the part of the name-of-data-for-insertion 908 of the data description cell 906.

As shown in FIG. 6, the user selects a column for hiding and selects “hide” from the menu so that the column is hidden by using the input device 104 including a pointing device, a keyboard, and so forth. Consequently, columns for outputting are selected. Accordingly, data of an arrangement of the identifiers of the selected columns is stored in the output-column storage area of the memory 102. If no column is selected for outputting, data of an arrangement of the identifiers of all of the columns generating the table is stored in the memory 102.

For example, if the user determines to hide “column 1”, as shown in FIG. 6, data of an arrangement of the identifiers of “column 0”, “column 2”, and “column 3” is stored.

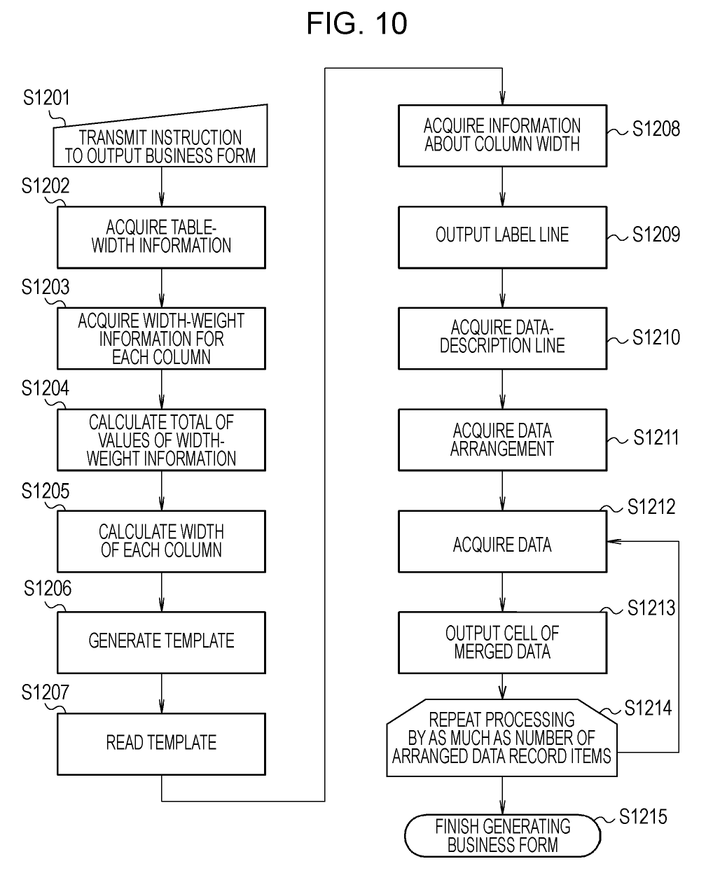

FIG. 10 is a flowchart showing processing procedures performed by the document generating system 100 according to the third embodiment of the present invention.

Upon receiving an instruction to perform business-form output processing, the instruction being transmitted from the user, at step S1201, the CPU 101 performs column-width calculating processing, so as to determine the column width, and the business-form output processing including merging data into the business form and outputting the business form.

First, the CPU 101 acquires the table width information 901 from the business-form template shown in FIG. 8 at step S1202.

Then, the CPU 101 acquires the width-weight information item 902 of the column corresponding to the identifier of a column of which data is stored in the output-column storage area which is a temporary storage area of the memory 102 at step S1203.

Next, at step S1204, the CPU 101 calculates the total of the values of the width-weight information items 902 of the columns, the width-weight information items 902 being acquired at step S1203.

The CPU 101 calculates the width of the column corresponding to the identifier of a column of which data is stored in the output-column storage area based on Equation (1) at step S1205.

Then, the CPU 101 acquires the table-label cell 905 corresponding to the column data acquired at step S1203 and the data description cell 906 in which the data-insertion destination is described from the business-form template data.

Next, the CPU 101 generates data of a business-form template including the label cells 905, where the width of each of the columns has the value calculated at step S1205 and the data description cells 906 at step S1206.

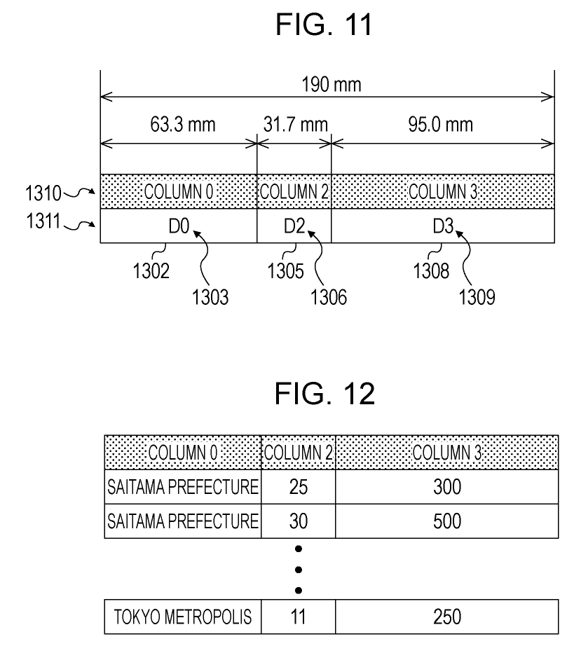

As a result of the above-described processing procedures, business-form template data shown in FIG. 11 is generated. Then, the processing advances to business-form generating processing procedures including data merging processing.

During the business-form generating processing procedures, the CPU 101 reads the business-form template data that is generated at step S1206 and that is shown in FIG. 11 at step S1207. Next, at step S1208, the CPU 101 acquires information about the width (in mm, for example) of each column, the information being described on a label line 1310 of the business-form template data read at step S1207.

Next, at step S1209, the CPU 101 outputs data of each of the label cells of the label line 1310 included in the business-form template data read at step S1207 to the printer 108 so that each of the label cells has a width indicated by the column-width information acquired at step S1208. The data of the label line 1310 may be transmitted to the external storage device 103 in place of the printer 108 as printable data including data of a portable-document-format (PDF) document, for example.

Then, at step S1210, the CPU 101 acquires data of a data-description line 1311 included in the business-form template data read at step S1207.

The data-record arrangement data for merging, which is exemplarily shown in FIG. 9, is acquired from the external storage device 103 at step S1211. The data-record arrangement data may be acquired from a database server or the like provided on the network 107 via the network interface 106.

The data-description line 1311 of the business-form template data includes data description cells 1302, 1305, and 1308.

Next, at step S1212, the CPU 101 acquires the data corresponding to data names 1303, 1306, and 1309 of which data is stored in the data description cells 1302, 1305, and 1308 from the data-record arrangement data acquired at step S1211.

Next, at step S1213, the CPU 101 merges the data acquired at step S1211 into the data description cells and transmits data of the data description cells to the printer 108 so that each of the data description cells has a width indicated by the width information acquired at step S1208. The data of the data description cells into which the data is merged may be transmitted to the external storage device 103 in place of the printer 108 as printable data including PDF document data or the like.

The CPU 101 performs the processing corresponding to steps S1211 to S1213 by as much as the number of records included in the data-record arrangement data at step S1214.

After the above-described processing is performed by as much as the number of the records included in the data-record arrangement data, the CPU 101 terminates the business-form generating processing at step S1215.

When the table is drawn through the above-described processing procedures, the first column has a width of 63.3 mm, the second column has a width of 31.7 mm, and the third column has a width of 95.0 mm, for example, so that the table has a width of 190 mm. Consequently, a business form into which the data-record arrangement data shown in FIG. 9 is merged is generated, as shown in FIG. 12.

Each of units and/or steps included in the above-described embodiments of the present invention can be achieved by an operating program stored in a random-access memory (RAM) and/or a read-only memory (ROM) of a computer. The program and/or a computer-readable storage medium (recording medium) storing the program constitutes another embodiment of the present invention.

Further, each of a system, an apparatus, a method, a program, a storage medium, etc. may constitute another embodiment of the present invention. More specifically, the present invention can be used for an apparatus including a single unit.

Further, program code of software implementing the functions of the above-described embodiments is supplied to the system and/or the apparatus directly and/or remotely. Then, a computer of the system and/or the apparatus reads and executes the supplied program code so that the functions of the above-described embodiments can be achieved, which constitutes another embodiment of the present invention.

Therefore, the program code itself installed in the computer, so as to achieve functional processing of the present invention by the computer, also constitutes another embodiment of the present invention. Namely, a computer program itself provided to achieve the functional processing can constitute another embodiment of the present invention. In that case, the above-described computer program may be object code, a program executed by an interpreter, script data supplied to an operating system (OS), etc., so long as the computer program has program functions.

Further, not only by the computer executing the read program, but also by the computer executing part of or the entire process utilizing an OS, etc. running on the computer based on instructions of the program, the functions of the above-described embodiments may be achieved.

Further, according to another method, the program read from the recording medium may be written into a memory of a function-expansion board inserted into the computer and/or a function-expansion unit connected to the computer. Then, a central processing unit (CPU), etc. of the function-expansion board and/or the function-expansion unit may execute part of or the entire process based on instructions of the program so that the functions of the above-described embodiments are achieved.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-103836 filed on Apr. 11, 2008, which is hereby incorporated by reference herein in its entirety.

What is claimed is:

1. A table generating method comprising the steps of:
calculating a total of values of weights set for widths of a plurality of columns included in a table; and
determining the width of each of the columns based on a width of a table, the total, and the weight set for the width of each of the columns.

2. The table generating method according to claim 1,
wherein, at the calculating step, weights set for widths of at least two columns selected from the columns are calculated, and
wherein, at the determining step, the width of each of the selected columns is determined based on the table width, a total of the weights set for the widths of the selected columns, and the weight set for the width of each of the selected columns.

3. The table generating method according to claim 1, wherein, for deleting a predetermined column of the columns included in the table, a width of the column which is not deleted from the table from which the predetermined column is deleted is determined so that a width of the table from which the predetermined column is deleted is equivalent to a width of the table from which the predetermined column is not deleted.

4. The table generating method according to claim 1, wherein the determining step includes the step of generating a table in which data corresponding to the column having the determined width is merged into the column having the determined width.

5. A table generating apparatus comprising:
a calculating unit configured to calculate a total of values of weights set for widths of a plurality of columns included in a table; and
a determining unit configured to determine the width of each of the columns based on a width of the table, the total, and the weight set for the width of each of the columns.

6. The table generating apparatus according to claim 5,
wherein the calculating unit calculates weights set for widths of at least two columns selected from the columns, and
wherein the determining unit determines the width of each of the selected columns based on the table width, a total of the weights set for the widths of the selected columns, and the weight set for the width of each of the selected columns.

7. The table generating apparatus according to claim 5, wherein, for deleting a predetermined column of the columns included in the table, the determining unit determines a width of the column which is not deleted from the table from which the predetermined column is deleted so that a width of the table from which the predetermined column is deleted is equivalent to a width of the table from which the predetermined column is not deleted.

8. The table generating apparatus according to claim 5, the determining unit includes a unit configured to generate a table in which data corresponding to the column having the determined width is merged into the column having the determined width.

9. A computer readable storage medium containing computer-executable instructions to generate a table, the medium comprising:
computer-executable instructions for calculating a total of values of weights set for widths of a plurality of columns included in a table; and
computer-executable instructions for determining the width of each of the columns based on a width of a table, the total, and the weight set for the width of each of the columns.

10. The medium according to claim 9,
wherein, at the calculating step, weights set for widths of at least two columns selected from the columns are calculated, and
wherein, at the determining step, the width of each of the selected columns is determined based on the table width, a total of the weights set for the widths of the selected columns, and the weight set for the width of each of the selected columns.

11. The medium according to claim 9,
wherein, for deleting a predetermined column of the columns included in the table, a width of the column which is not deleted from the table from which the predetermined column is deleted is determined so that a width of the table from which the predetermined column is deleted is equivalent to a width of the table from which the predetermined column is not deleted.

12. The medium according to claim 9, wherein the determining step includes the step of generating a table in which data corresponding to the column having the determined width is merged into the column having the determined width.
